(19) United States
(12) Patent Application Publication
(10) Pub. No.: US 2021/0309882 A1
(43) Pub. Date: Oct. 7, 2021

(54) COATING COMPOSITIONS

(71) Applicant: Hewlett-Packard Development Company, L.P., Spring, TX (US)

(72) Inventors: Zhang-Lin Zhou, San Diego, CA (US); Xiaoqi ZHOU, San Diego, CA (US)

(73) Assignee: Hewlett-Packard Development Company, L.P., Spring (US)

(21) Appl. No.: 17/268,608

(22) PCT Filed: Dec. 18, 2018
(86) PCT No.: PCT/US2018/066169

§ 371 Date: Feb. 16, 2021

(51) Int. Cl. C09D 175/06; C08K 3/28; C08G 18/08; C08G 18/12; C08G 18/32; C08G 18/38; C08G 18/42; C08G 18/66; C08G 18/75; B05D 5/04; C08L 71/02; C08L 79/02

(52) U.S. Cl. CPC C09D 175/06; B05D 2401/21; C08G 18/0828; C08G 18/0852; C08G 18/12; C08G 18/3206; C08G 18/3857; C08G 18/4238; C08G 18/664; C08G 18/755; B05D 5/04; C08L 71/02; C08L 79/02; C08K 2003/287; B05D 2203/22; C08K 3/28

(57) ABSTRACT

A coating composition can include water and polyurethane particles including sulfonated- or carboxylated-diamine groups, isocyanate-generated amine groups, and polyalkylene oxide side-chains.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new print media, for example.

### BRIEF DESCRIPTION OF DRAWINGS

FIG. 1 schematically depicts an example coating composition for coating print media substrates in accordance with the present disclosure;

FIG. 2 schematically depicts an example coated print media in accordance with the present disclosure;

FIG. 3 provides a flow diagram for an example method of making coated print media in accordance with the present disclosure; and

FIG. 4 shows example portions of polyurethane particles that can be included in coating compositions and print media coatings in accordance with the present disclosure.

### DETAILED DESCRIPTION

The present technology relates to coating compositions for print media, coated print media, and methods for making print media. In one example, a coating composition, such as can be used for print media, includes water and polyurethane particles. The polyurethane particles includes sulfonated- or carboxylated-diamine groups, isocyanate-generated amine groups, and polyalkylene oxide side-chains. The polyurethane particles can have a D50 particle size from 20 nm to 300 nm. The polyurethane particles can have an acid number from 0 mg KOH/g to 30 mg KOH/g. The polyalkylene oxide side-chains can include polyethylene oxide side-chains, polypropylene oxide side-chains, or a combination thereof. The polyalkylene oxide side-chains can have a number average molecular weight from 500 Mn to 15,000 Mn. In one example, the coating composition can further include a fixing agent. The fixing agent can be a metal inorganic salt, metal organic salt, cationic polymer, or a combination thereof. The polyurethane particles and the fixing agent, if present, can be included in the coating composition at a weight ratio from 2:1 to 20:1. In one example, the polyurethane particles can further include polymerized nonionic aliphatic diols.

In another example, a coated print medium includes a media substrate and an ink-receiving layer on the media substrate. The ink-receiving layer includes polyurethane particles including sulfonated- or carboxylated-diamine groups, isocyanate-generated amine groups, and polyalkylene oxide side-chains. In one example, the polyalkylene oxide side-chains include polyethylene oxide side-chains, polypropylene oxide side-chains, or a combination thereof. The polyalkylene oxide side-chains can have a number average molecular weight from 500 Mn to 5,000 Mn. In one example, the coating composition can further include a fixing agent. The fixing agent can be a metal inorganic salt, metal organic salt, cationic polymer, or a combination thereof. For example, the fixing agent can include cationic polymer, such as an alkylated quaternary polyamine cationic polymer or an ionene cationic polymer. The polyurethane particles and the fixing agent, if present, can be included in the coating composition at a weight ratio from 2:1 to 20:1. In another example, the ink-receiving layer can include inorganic particulate filler having a D50 particle size from 100 nm to 5 μm, for example. The polyurethane particles and the inorganic particulate filler can be present in the ink-receiving layer at a weight ratio from 20:1 to 1:3. In further detail, the media substrate can be paper, fabric, plastic film, metallic foil, or a combination or composite thereof.

In another example, a method of making a coated print medium includes applying a coating composition as a layer to a media substrate, and drying the coating composition to remove water from the media substrate to leave an ink-receiving layer thereon. The coating composition includes water and polyurethane particles including sulfonated- or carboxylated-diamine groups, isocyanate-generated amine groups, and polyalkylene oxide side-chains. In one example, the polyalkylene oxide side-chains can include polyethylene oxide side-chains, polypropylene oxide side-chains, or a combination thereof. The polyalkylene oxide side-chains can have a number average molecular weight from 500 Mn to 15,000 Mn. The coating composition can further include fixing agent including cationic inorganic salt, metal organic salt, cationic polymer, or a combination thereof.

It is noted that when discussing the coating compositions, coated print media, and methods of making coated print media, these discussions can be considered applicable to one another whether or not they are explicitly discussed in the context of that example. Thus, for example, when discussing a polyalkylene oxide side-chain related to the coating compositions, such disclosure is also relevant to and directly supported in the context of the coated print media and methods of making coated print media, and vice versa, etc. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

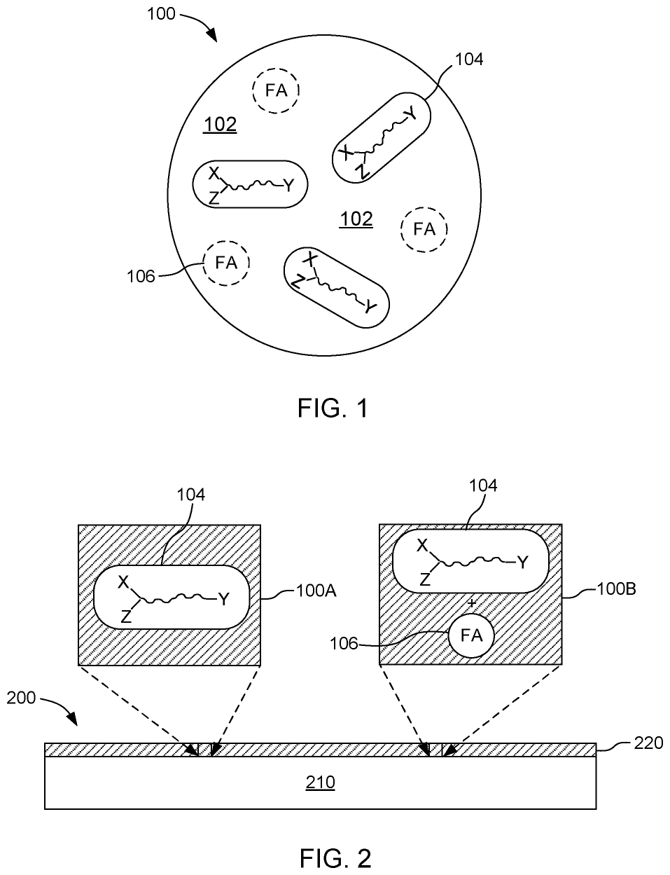

Turning now to more specific detail regarding the coating compositions, as shown in FIG. 1, an example coating composition 100 can include liquid vehicle or carrier vehicle 102, which includes water, and polyurethane particles 104, which are shown schematically in this FIG. and not by way of limitation. Also, shown in dashed lines, there can also be a fixing agent 106 present in the coating composition in some examples, such as metal inorganic salt, metal organic salt, and/or cationic polymer. The fixing agent can have multiple charge centers, e.g., multivalent metal salt, monovalent metal salts with multiple charge centers (organic salts), polymers with multiple charge centers, etc. The polyurethane particles can include sulfonated- or carboxylated-diamine groups, shown at “X”, isocyanate-generated amine groups, shown at “Y”, and polyalkylene oxide side-chains, shown at “Z.” These locations are shown schematically, and could be at any other available location other than that which is shown. With specific reference to the isocyanate-generated amine groups, these may be generated by molar excess of isocyanate groups not used in forming the polymer precursor, and then upon reaction with water, carbon dioxide gas is liberated leaving the terminal amino group or an amine group along the backbone of the polyurethane polymer. The polyurethane particles and the fixing agent, if present, can be included in the coating composition at a weight ratio from 2:1 to 20:1, from 3:1 to 15:1, from 4:1 to 12:1, or from 5:1 to 10:1, for example. In further detail, one benefit of the polyurethane particles of the present disclosure can be that the polyurethanes particles can be prepared so that they can be “compatible” with the fixing agent, meaning that they can be admixed in a common coating composition with without precipitation, gelling, or solution clouding, for example.

FIG. 2 provides an example coated print medium 200 with the coating composition of FIG. 1 at 100 having been applied to a media substrate 210 and dried, leaving an ink-receiving layer 220 thereon. In one example, shown at 100A, the ink-receiving layer includes the polyurethane particles 104, and as shown at 1006, the ink-receiving layer can alternatively include both the polyurethane particles and the fixing agent 106.

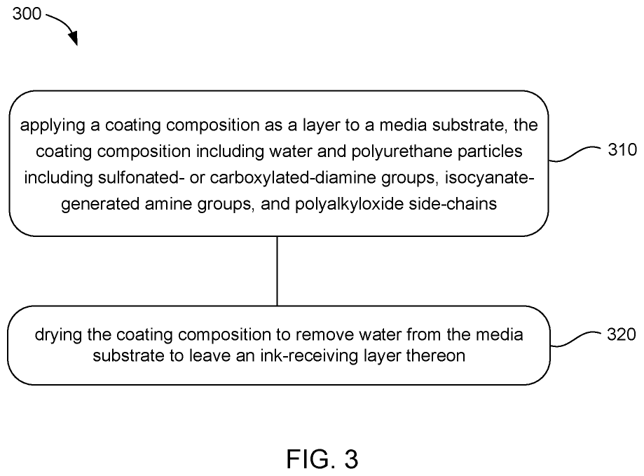

FIG. 3 depicts a method 300 of making a coated print medium that includes applying 310 a coating composition as a layer to a media substrate, and drying 320 the coating composition to remove water from the media substrate to leave an ink-receiving layer thereon. The coating composition includes water and polyurethane particles. The polyurethane particles include sulfonated- or carboxylated-diamine groups, isocyanate-generated amine groups, and polyalkylene oxide side-chains.

The term “isocyanate-generated amine groups” refers to amino (—NH₂) groups that can be generated from excess isocyanate (NCO) groups that are not utilized when forming the polymer precursor, typical present as terminal groups; or to secondary amine (—NH—) groups that may be isolated from other functional groups present along the polymer backbone, e.g., —CH₂CH₂—NH—CH₂—. These groups can be generated from excess isocyanate (NCO) groups that are not utilized when forming polymer precursor or at other stages in the reaction/preparation of the polyurethane polymer. Upon reacting with water (rather than being used to form the polymer backbone with a diol) the excess isocyanate group can release carbon dioxide, leaving an amino or secondary amine group where the isocyanate group was previously present.

In further detail, as mentioned, there can be two different types of amine groups present on the polyurethane particles, namely sulfonated- or carboxylated-alky diamine groups and isocyanate-generated amine groups. The sulfonated- or carboxylated alky diamine groups can be reacted with a polymer precursor, resulting in some examples as a pendant side chain with one of the amine groups attaching the pendant side chain to a polymer backbone and the other amine group and sulfonate or carboxylate group being present along the pendant side chain. As an example of a carboxylate- or sulfonated diamine, Formula I below shows an alkylamine-alkylamine sulfonate (shown as a sulfonic acid, but as a sulfonate, would include a positive counterion associated with an SO₃⁻ group), that can be used to form the polyurethane particles of the present disclosure, though there are others, including other alkyl diamines sulfonates, alkyl diamine carboxylates, alicyclic diamine sulfonates, alicyclic diamine carboxylates, aromatic diamine sulfonates, aromatic diamine carboxylates, or combinations thereof. Thus, the alkyl diamine sulfonates shown in Formula I is below is provide by way of example, as follows:

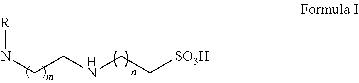

where R is H or is C1 to C10 straight- or branched-alkyl or alicyclic or combination of alkyl and alicyclic, m is 1 to 5, and n is 1 to 5. One example of such a structure sold by Evonik Industries (USA) is A-95, which is exemplified where R is H, m is 1, and n is 1. Another example structure sold by Evonik Industries is Vestamin®, where R is H, m is 1, and n is 2.

The isocyanate-generated amine groups, on the other hand, can be generated from excess isocyanate (NCO) groups that are not utilized when forming the polymer precursor, as also mentioned. In further detail, the isocyanate-generated amine groups can be present on the polyurethane particles at from 2 wt % to 8 wt % compared to a total weight polyurethane particle.

The polyurethane particles, as mentioned, also include polyalkylene oxide side-chains, shown schematically at “C,” for example. These side-chains can be grafted onto polyurethane polymers, such as Sancure™ polyurethanes are available from Lubrizol Advanced Materials, Inc., USA, or Impranil® polyurethanes are available from Covestro AG, Germany. However, if left unmodified, these polyurethanes are not polyurethanes are not considered to have polyalkyeneoxide side-chains. The polyalkylene oxide side-chains can include polyethylene oxide side-chains, polypropylene oxide side-chains, or a combination thereof. The polyalkylene oxide side-chains can have a number average molecular weight from 500 Mn to 15,000 Mn, or from 1,000 Mn to 12,000 Mn, from 2,000 Mn to 10,000 Mn, or from 3,000 Mn to 8,000 Mn. These side-chains can provide one example benefit of assisting the polyurethane particles with compatibility when co-formulated with a fixing agent, for example. The polyurethane particles can have a D50 particle size from 20 nm to 300 nm, from 75 nm 250 nm, or from 125 nm to 250 nm, for example. The weight average molecular weight can be from 30,000 Mw to 300,000 Mw, from 50,000 Mw to 250,000 Mw, or from 100,000 Mw to 200,000 Mw. The acid number of the sulfonated polyurethane particles can be from 0 mg KOH/g to 30 mg KOH/g, from 2 mg KOH/g to 20 mg KOH/g, or from 4 mg KOH/g to 15 mg KOH/g, for example.

By way of example, the polyurethane particles of the present disclosure can be prepared, in one example, by reacting a diisocyanate with a polymer diol and a small molecule diol, e.g., in the presence of a catalyst in acetone under reflux, to give a compound ready for grafting in the polyethylene oxide (PEO) and/or polypropylene oxide (PPO). Thus, pre-polymer synthesis can include reaction of a diisocyanate with polymeric diol and a small molecular aliphatic diol, for example. The term “aliphatic” as used herein includes saturated C2 to C16 aliphatic groups, such as alkyl groups, alicyclic groups, combinations of alkyl and alicyclic groups, etc., and can include straight-chain alkyl, branched alkyl, alicyclic, branched alkyl alicyclic, straight-chain alkyl alicyclic, alicyclic with multiple alkyl side chains, etc. For example, the small molecule nonionic aliphatic diol can have from C2 to C16 carbon atoms, for example; or if the sulfonated- or carboxylated-diamine group(s) are described as aliphatic diamines, they can include sulfonated- or carboxylated C2 to C16 carbons in addition to being a diamine.

The reaction can occur in the presence of a catalyst in acetone under reflux to give the pre-polymer, in one example. In some specific examples, other reactants may also be used in certain specific examples, such as organic acid diols (in addition to the polymeric diols) to generate acidic moieties along the backbone of the polyurethane particles. Thus, in addition to diols that may be used to react with the isocyanate groups to form the urethane linkages, a carboxylated diol may likewise be used to react with the diisocyanates to add carboxylated acid groups along a backbone of the polyurethane polymer of the polyurethane particles.

The pre-polymer can be prepared with excess isocyanate groups that compared the molar concentration of the alcohol groups found on the polymeric diols or other diols that may be present. By retaining excess isocyanate groups, in the presence of water, the isocyanate groups can generate amino groups or secondary amines along the polyurethane chain, releasing carbon dioxide as a byproduct. This reaction can occur at the time of chain extension during the process of forming the polyurethane particles. Once the pre-polymer is formed, the polyurethane particles can be generated by reacting the pre-polymer with mono-substituted polyethylene oxide (PEO) alcohol and/or polypropylene oxide (PPO) alcohol, and then with sulfonated- or carboxylated-diamines, to form the polyurethane particles that include the sulfonated- and/or carboxylated-diamine moieties and the polyalkylene oxide moieties. As noted in preparing the pre-polymer, with an excess of isocyanate groups and with the reaction with water, the polyethylene particles also include isocyanate-generated amine groups as well. Next, more water can be added and solvent can be removed by vacuum distillation in some examples, thus, suspending the polyurethane particles in a higher concentration of water. With specific reference to the sulfonated- and/or carboxylated diamine moieties, some may participate in intra-polymer or inter-polymer crosslinking, and some may not participate in crosslinking. Thus, even with some sulfonated- and/or carboxylated diamine moieties not participating in crosslinking, the grafted side chains provided by the PPO and/or PEO moieties can provide protection to the sulfonate and/or carboxylate groups, inhibiting their interaction with any salt or cationic polymer that may be present therewith as a fixing agent, for example.

An example preparation scheme is shown in Table 1, which sets for various steps in one example sequence, as follows:

TABLE 1

| Step | | |
|---|---|---|
| 1 | Initial Reactants | Diisocyanate + Polymeric Diol + Nonionic |
| | | Aliphatic Diol + Catalyst/Acetone → |
| 2 | Prepolymer | Formation Backbone Including Excess Isocyanate |
| | | Groups and Urethane Linkages Generated From |
| | | Polymeric Diols and Nonionic Aliphatic Diols |
| 3 | Polyalkylene Oxide | OH-PEO and/or OH-PPO → |
| | Alcohol Reactant | |
| 4 | Intermediate Polymer | Prepolymer Modified with Polyalkylene Pendant |
| | | Groups Attached Via Urethane Linkages with Excess |
| | | Isocyanate Groups Remaining |
| 5 | Acid-Diamine Reactant | Sulfonated- or Carboxylated-Diamine Groups → |
| 6 | Acidified Polymer | Intermediate Polymer Modified with Sulfonated- or |
| | | Carboxylated-Diamine Groups with Excess Isocyanate |
| | | Groups Remaining |
| 7 | Aqueous Dispersion | Water (Remove Acetone) → |
| 8 | Polyurethane Particles | Polyurethane Particle Dispersion Including Sulfonated- |
| | Dispersed in Water | or Carboxylated-Diamine Groups, Isocyanate- |
| | | Generated Amine Groups, and Polyalkylene oxide |
| | | Side-Chains |

Notably, the excess isocyanate groups can be converted to the isocyanate-generated amine groups at any of the stages shown in Table 1 above when there is water for the reaction. Any of the isocyanate groups that may be still be present when water is added would at that point be converted to the isocyanate-generated amine groups. These amine groups can be available for crosslinking, for example.

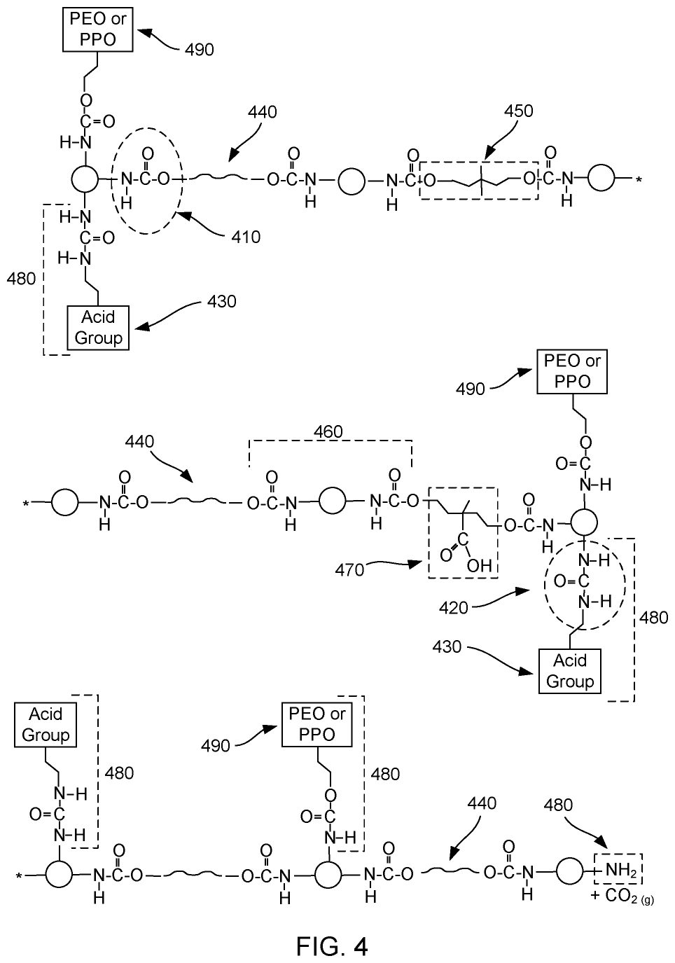

FIG. 4 provides example portions of polyurethane particles that can be formed, for example in accordance with the preparative scheme of Table 1 or other similar reaction scheme. This FIG. does not show the cross-linking, but rather shows the types of groups or moieties that can be present along the polymer of the polyurethane particles, some of which can be available for internal crosslinking. In FIG. 4, the polyurethane polymer portions shown identify several urethane linkage groups 410, urea groups 420, acid groups (sulfonic acid or carboxylic acid) 430 of example acid-diamines 80 (sulfonated- or carboxylated-diamines), polymerized polymeric diols 440, and polymerized nonionic aliphatic diols 450. Notably, the polymerized polymeric diols and the polymerized nonionic aliphatic diols liberate hydrogens at their hydroxyl moieties to form the urethane linkage groups in some locations. As shown also in FIG. 4, polymerized diisocyanates 460 are also shown, which include urethane linkage groups on either side of a central moiety, with the central moiety being generically as a circle. The central moiety of the polymerized diisocyanates may be provided from any of the diisocyanates shown and/or described herein, or any of a number of other diisocyanates, or can also be representative of multiple different types of diisocyanates used in combination. Thus, the central moieties (shown as a circle) from the diisocyanates can actually be different at the various locations where this central moiety, or circle, is shown in FIG. 4. As another example, there can also be other types of compounds included in the polymerized polyurethane particles beyond that which is shown in Table 1. For example, one of the polyurethane particle portions identifies an example polymerized organic acid diol 470, which is generated from an organic acid diol, e.g., 2,2-bis(hydroxymethyl)propionic acid in this instance. This can be added when generating the prepolymer with the other diols, for example. If an organic acid diol is used, it can be used in addition to the polymeric diol and/or the nonionic aliphatic diol previously described, thus providing a carboxylate group coupled directly to a polymer backbone of the polyurethane polymer in addition to the polymeric or oligomeric portions provided by the polymeric diol. Also shown is an isocyanate-generated amino group 480. This can be generated from any excess isocyanate groups, such as those not otherwise used for other types of polymer modification, e.g., appending acidic-diamines and/or polyalkylene oxides to the polymer. Thus, in examples of the present disclosure, the polyurethane polymer can be self-crosslinked, self-crosslinkable, can include a sulfonated- or carboxylated-diamine, a nonionic aliphatic diol, and an isocyanate-generated amine group, e.g., isocyanate-generated amino group. Other groups may also be present, such as a polymerized organic acid diol, for example. In some examples, it is noted that the isocyanate-generated amine group shown can further react with isocyanates to form additional urethane bonds for crosslinking reactions. However, there can also be amino groups or secondary amines present that remain available for additional crosslinking to print media substrates, printed ink components, etc.

In more specific detail regarding the initial reactants and then additional reactants that can be used in forming the polyurethane particles, example diisocyanates that can be used to prepare the pre-polymer include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexan (H12MDI), etc., or combinations thereof, as shown below. Others can likewise be used alone, or in combination with these diisocyanates, or in combination with other diisocyanates not shown.

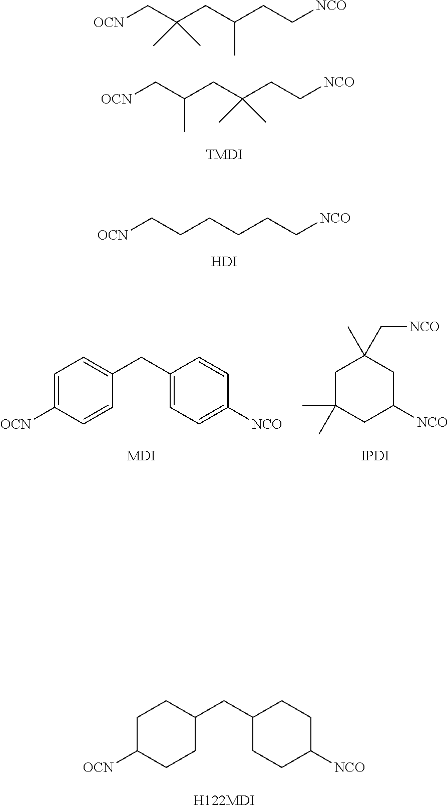

In further detail, there are also polymeric diols as well as small molecular nonionic aliphatic diols that can be used in preparing the polyurethane particles of the present disclosure. Example polymeric diol include polyester diols or a polycarbonate diols, for example. Other polymeric diols that can be used include polyether diols, or even combination diols, such as a combination that could be used to form a polycarbonate ester polyether-type polyurethane. In one specific example, however, the polyurethane particles can include polyester polyurethane moieties.

Regarding the nonionic aliphatic diols, these can typically be small molecular diols, e.g., up to an atomic mass of about 300 or defined as having from 2 to 16 carbon atoms, and can be included in addition to the polymeric diols described above. The nonionic aliphatic diols of the present disclosure can be included in the polyurethane particles, providing additional chain extension of polyurethane dispersions. Examples of nonionic aliphatic diols that can be used include various alkyl and/or alicyclic diols, including those shown as follows:

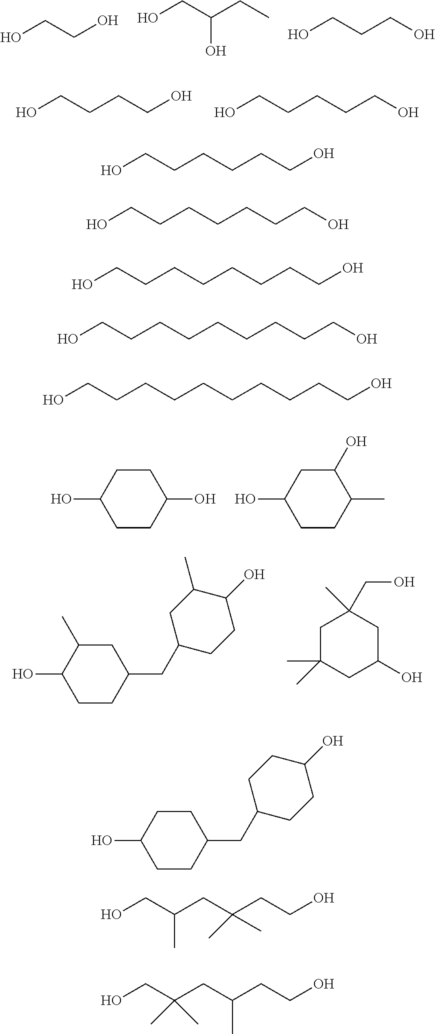

Once the pre-polymer is formed, the polyurethane particles can be generated to

include the polyalkylene oxide groups as well as the sulfonated- or carboxylated-diamine groups appended on to the polyurethane polymer backbone. As also previously noted, with an excess of isocyanate groups and the presence or introduction of water, the polyethylene particles can also include isocyanate-generated amine groups as well.

With more specific reference to the polyalkylene oxide moieties that can be included, these can be grafted onto the polymer backbone by reacting the pre-polymer with mono-substituted polyalkylene oxide alcohol, such as polyethylene oxide (PEO) alcohol and/or polypropylene oxide (PPO) alcohol, for example. The polyalkylene oxide side-chains that are added or grafted to the polymer backbone can have a number average molecular weight from 500 Mn to 15,000 Mn, from 1,000 Mn to 12,000 Mn, from 2,000 Mn to 10,000 Mn, or from 3,000 Mn to 8,000 Mn, for example. Within these ranges of repeating C2-C3 alkyl oxide groups, polypropylene oxide groups can provide greater weight average molecular weight to the side-chain compared to polyethylene oxide, as there are three carbons present per oxygen compare to two carbons per oxygen. In some examples the polyalkylene oxide side-chains can also be a combination of both C2 alkyl oxide groups and C3 alkyl oxide groups. In connection with the sulfonated- and/or carboxylated diamine moieties, some may participate in intra-polymer or inter-polymer crosslinking, and some may not participate in crosslinking. However, even when some sulfonated- and/or carboxylated diamine moieties do not participate in crosslinking, the grafted side chains provided by the PPO and/or PEO moieties can provide protection to the sulfonate and/or carboxylate groups, inhibiting their interaction with any salt or cationic polymer that may be present therewith as a fixing agent, for example.

With respect to the sulfonated- or carboxylated-diamines that can be used in forming the polyurethane particles as described herein, they can be prepared from any of a number of diamine compounds by adding carboxylate or sulfonate groups thereto. Example diamines can include various dihydrazides, alkyldihydrazides, sebacic dihydrazides, alkyldioic dihydrazides, aryl dihydrazides, e.g., terephthalic dihydrazide, organic acid dihydrazide, e.g., succinic dihydrazides, adipic acid dihydrazides, etc, oxalyl dihydrazides, azelaic dihydrazides, carbohydrazide, etc. Example diamine structures are shown below, with some specific examples of diamines including 4,4′-methylenebis(2-methylcyclohexyl-amine) (DMDC), 4-methyl-1,3′-cyclohexanediamine (HTDA), 4,4′-Methylenebis(cyclohexylamine) (PACM), isophorone diamine (IPDA), tetramethylethylenediamine (TMDA), ethylene diamine (DEA), 1,4-cyclohexane diamine, 1,6-hexane diamine, hydrazine, adipic acid dihydrazide (AAD), carbohydrazide (CHD), and/or diethylene triamine (DETA), notably, DETA includes three amine groups, and thus, is a triamine. However, since it also includes two amines, it is considered to fall within the definition herein of “diamine,” meaning it includes two amine groups. Many of the diamine structures shown below can be used to form the sulfonated- or carboxylated diamine, and thus are shown by way of example below:

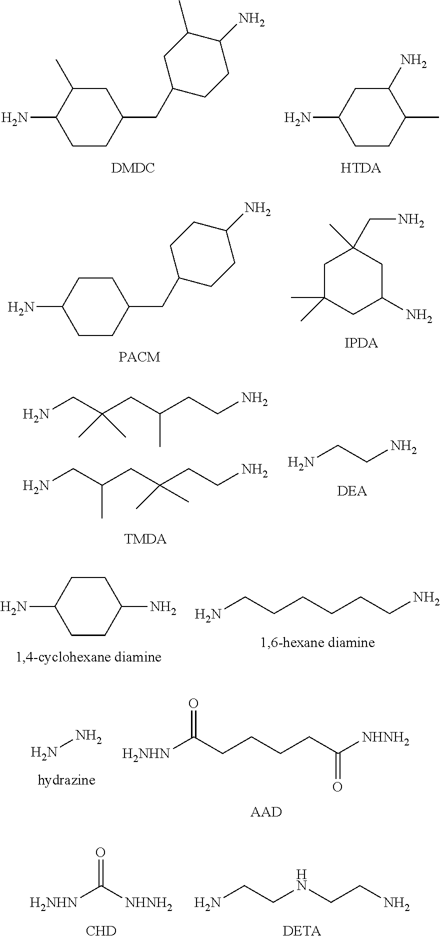

There are also other alkyl diamines (other than 1,6-hexane diamine) that can be used, such as, by way of example:

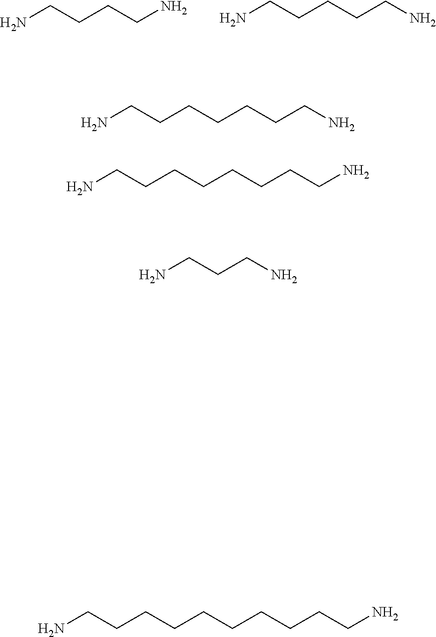 [SMILES: NCCCCN ; NCCCCCN ; NCCCCCCCN ; NCCCCCCCCN ; NCCCN ; NCCCCCCCCCCN]

There are also other dihydrazides (other than AAD shown above) that can be used, such as, by way of example:

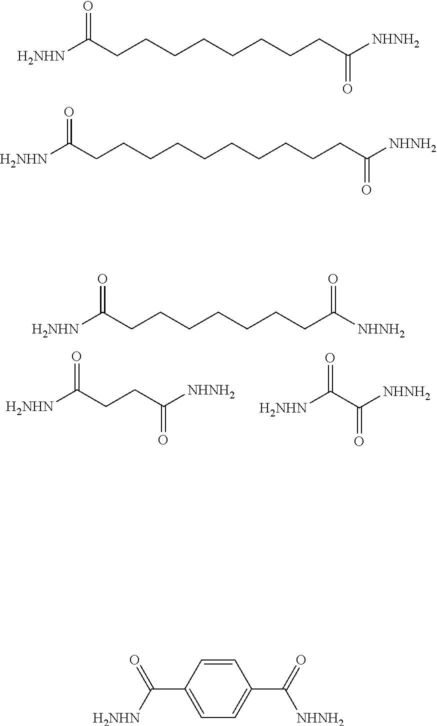

As mentioned, in accordance with examples of the present disclosure, a fixing agent can be included in the coating composition and on the coated media substrate. The fixing agent can be any species of chemical compounds which carry multiple positive charge center. For metal salts with one metal, the multiple positive charges can be found in a single multivalent metal, or for salts with multiple metals, the multiple positive charge centers can be from multiple monovalent and/or divalent metals.

In one examples, the fixing agent can be selected from inorganic multivalent metallic salts, such as Group II metals or Group III metals. Example cationic transition metals that can be used include, without limitation, calcium, copper, nickel, magnesium, zinc, barium, iron, aluminum, chromium, or a combination thereof. Example anionic species that can be used include chloride, iodide, bromide, nitrate, sulfate, sulfite, phosphate, chlorate, acetate, or combinations thereof.

In another example, the fixing agent can be selected from the organic metallic salts. Organic metallic salt are ionic compounds composed of cations and anions with a formula such as (CₙH₂ₙ₊₁COO⁻M⁺)*(H₂O)ₘ, where M⁺ is cation species including Group I metals, Group II metals, or Group III metals, for example. Transition metals and other monovalent metals that can be used include, for example, sodium, potassium, calcium, copper, nickel, zinc, magnesium, barium, iron, aluminum, chromium, or a combination thereof. Anion species can include any negatively charged carbon species with a value of n from 1 to 35. The hydrates (H₂O) are water molecules attached to salt molecules with a value of m from 0 to 20. Examples of water soluble salts include, but are not limited to, calcium acetate monohydrate, calcium propionate, calcium propionate hydrate, calcium formate, etc.

Further, in other examples, fixing agent can be a cationic polymer with multiple charge centers. Cationic polymer may have cationic groups as part of the main chain (polymer backbone) or as part of an appended side-chain (pendent group). In one example, the cationic polymer can be a naturally occurring polymer such as cationic gelatin, cationic dextran, cationic chitosan, cationic cellulose, cationic cyclodextrin, etc. The cationic polymer can also be a synthetically modified naturally occurring polymer such as a modified chitosan, e.g., carboxymethyl chitosan, N, N, N-trimethyl chitosan chloride, etc. In one specific example, the cationic polymer can be a polymer having cationic groups as part of the main chain, such as an alkoxylated quaternary polyamine having the structure of Formula II, as follows:

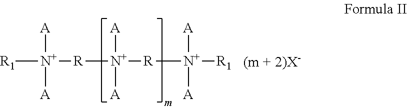

where R, R₁ and A can be the same group or different groups, such as linear or branched C₂-C₁₂ alkylene, C₃-C₁₂ hydroxyalkylene, C₄-C₁₂ dihydroxyalkylene, or dialkylarylene; X can be any suitable counter ion, such as halogen, chloride, bromide, iodide, etc., or other similarly charged anions; and m can be a numeral suitable to provide a polymer having a weight average molecular weight ranging from 100 Mw to 8000 Mw. In this example, the nitrogen atoms along the backbone can be quaternized. Formula II relates to the various commercial products with the trade name Floquat™, which are cationic polymers available from SNF (UK) Ltd., United Kingdom.

In another example, an ionene polymer can used, which is a polymer having ionic groups that are appended to the backbone unit as a side-chain, with an example including quaternized poly(4-vinyl pyridine), having the structure of Formula III, as follows:

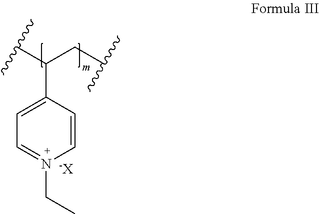

Again, in this example, X can be any suitable counter ion, such as halogen, chloride, bromide, iodide, etc., or other similarly charged anions; and m can be a numeral suitable to provide a polymer having a weight average molecular weight ranging from 100 Mw to 8000 Mw.

In yet another example, the cationic polymer can include polyamines and/or a salts thereof, polyacrylate diamines, quaternary ammonium salts, polyoxyethylenated amines, quaternized polyoxyethylenated amines, polydicyandiamides, polydiallyldimethyl ammonium chloride polymeric salts, or quaternized dimethylaminoethyl(meth)acrylate polymers. In another example, the cationic polymer can include polyimines and/or salts thereof, such as linear polyethyleneimines, branched polyethyleneimines, or quatemized polyethylenimines. In another example, the ionene polymer can include a substitute polyurea such as poly[bis(2-chloroethyl)ether-alt-1,3 bis[3-(dimethylamino)propyl]urea], or quaternized poly[bis(2 chloroethyl)ether-alt-1,3-bis[3-(dimethylamino)propyl]. In another example, the cationic polymer can be a vinyl polymer and/or a salt thereof, such as quaternized vinyl imidazol polymers, modified cationic vinyl alcohol polymers, or alkyl guanidine polymers.

In addition to the fixing agent, the coating composition and coating present on the coated media substrate can also include particulate fillers. Examples can include inorganic pigment(s), such as white inorganic pigments if the media is intended to be white, for example. Examples of inorganic pigments that may be used include, but are not limited to, aluminum silicate, kaolin clay, a calcium carbonate, silica, alumina, boehmite, mica and talc, and combinations or mixtures thereof. In some examples, the inorganic pigment includes a clay or a clay mixture. In some examples, the inorganic pigment includes a calcium carbonate or a calcium carbonate mixture. The calcium carbonate may be one or more of ground calcium carbonate (GCC), precipitated calcium carbonate (PCC), modified GCC, and modified PCC, for example. For example, the inorganic pigment may include a mixture of a calcium carbonate and a clay. The particulate fillers can have average particle size ranged from 0.1 μm to 20 μm, with a dry weight ratio of polyurethane particles to particulate filler ranging from 100:1 to 1:20, from 50:1 to 10:1, from 20:1 to 5:1, or from 10:1 to 1:1, for example. A specific example of a particulate filler that can be used is NuCap®, which is available from Kamin, LLC, USA.

In some examples, there are other additives that can be used or included, such as coating composition thickener, such as Tylose® HS-100K, available from SE Tylose GmbH & Co. KG, Germany. Surfactant, such as Pluronic® L61, available from BASF SE, Germany, can also be included. Other commercially-available surfactant that can be used includes the TAMOL™ series from Dow Chemical Co., nonyl and octyl phenol ethoxylates from Dow Chemical Co. (e.g., Triton™ X-45, Triton™ X-100, Triton™ X-114, Triton™ X-165, Triton™ X-305 and Triton™ X-405) and other suppliers (e.g., the T-DET™ N series from Harcros Chemicals), alkyl phenol ethoxylate (APE) replacements from Dow Chemical Co., Elementis Specialties, and others, various members of the Surfynol® series from Air Products and Chemicals, (e.g., Surfynol® 104, Surfynol® 104A, Surfynol® 104BC, Surfynol® 104DPM, Surfynol® 104E, Surfynol® 104H, Surfynol® 104PA, Surfynol® 104PG50, Surfynol® 104S, Surfynol® 2502, Surfynol® 420, Surfynol® 440, Surfynol® 465, Surfynol® 485, Surfynol® 485W, Surfynol® 82, Surfynol® CT-211, Surfynol® CT-221, Surfynol® OP-340, Surfynol® PSA204, Surfynol® PSA216, Surfynol® PSA336, Surfynol® SE and Surfynol® SE-F), Capstone® FS-35 from DuPont, various fluorocarbon surfactants from 3M, E.I. DuPont, and other suppliers, and phosphate esters from Ashland, Rhodia and other suppliers. Dynwet® 800, for example, from BYK-chemie, Gmbh (Germany), can also be used.

When applying the coating composition to a media substrate, the coating composition can be applied to any media substrate type using any method appropriate for the coating application properties, e.g., thickness, viscosity, etc. Non-limiting examples of methods include size press, slot die, blade coating, and Meyer rod coating. Size presses, for example, can include puddle-sized press, film-sized press, or the like. The puddle-size press may be configured as having horizontal, vertical, or inclined rollers. The film-sized press may include a metering system, such gate-roll metering, blade metering, Meyer rod metering, or slot metering. In one example, a film-sized press with short-dwell blade metering can be used as an application head in view of applying the coating composition. In another example, a film-sized press is used to apply the coating composition to a paper substrate or a fabric substrate (or other type of substrate). The coating composition can be applied to a paper substrate, for example, off-line or in-line of a paper-making machine. Subsequently, when the coating composition is dried, it can form an ink-receiving layer. Drying can be by air drying, heated airflow drying, baking, infrared heated drying, etc. Other processing methods and equipment can also be used. For one example, the coated media substrate can be passed between a pair of rollers, as part of a calendering process, after drying. The calendering device can be any kind of calendaring apparatus, including but not limited to off-line super-calender, on-line calender, soft-nip calender, hard-nip calender, or the like.

In further detail and by way of example, a paper substrate can be modified on single or both sides with the ink-receiving layer. In one example, the ink-receiving layer cab gave a gloss level from 30 to 85 percent, as measured at a TAPPI (Technical Association of the Pulp and Paper Industry) angle of 75 degrees. In one example, the ink-receiving layer can formed on a media substrate with a dried coating weight from 3 grams/m² (gsm) to 20 gsm, from 4 gsm to 18 gsm, from 5 gsm to 15 gsm, or from 6 gsm to 12 gsm. The coatings of the present disclosure can be applied with acceptable smoothness, as well to provide the ability of the coated media to absorb ink or to evenly distribute ink colorant, e.g., pigment. Furthermore, the coating composition, when applied to a media substrate as a coating there can act to favorably have an impact on media opacity, brightness, whiteness, glossiness, and/or surface smoothness of image-receiving layer in some examples.

The coating compositions, coated print media, and methods of coating print media described herein can be suitable for use with many types of print media, including paper, fabric, plastic film, metallic foil, and other types of printable substrates, including combinations and/or composites thereof. In particular, papers can include chemical pulps and mechanical pulps, e.g., wood containing pulps. Chemical pulp refers to pulp that has been subjected to a chemical process where the heat and chemicals break down the lignin (the substance that binds the cellulose fibers together) without significant degrading the cellulose fibers. This process removes the lignin from the pulp to thereby yield cellulose fibers with very small amount of lignin. In mechanical pulp production, the logs of wood are pressed on grinding stones by means of mechanical presses. The wood is split into fibers with the help of water. As a result of which, the wood fibers are released but still contain a large variety of contaminants. The mechanical pulp used in the current disclosure can be further divided into groundwood pulp and the thermo-mechanical pulp (TMP). TMP pulp may be chemically enhanced in some cases, and in such cases, it is referred to as chemo-thermo-mechanical pulp (CTMP). Thus, any kind of cellulose paper stock may be used in the current disclosure, such as paper stock made from wood or non-wood pulps. Non-limitative examples of suitable pulps include chemical pulps, mechanical wood pulp, chemically ground pulp, chemical-mechanical pulp, thermal-mechanical pulp, recycled pulp and/or mixtures.

In another example, textiles or fabrics can be treated with the coating compositions of the present disclosure, including cotton fibers, treated and untreated cotton substrates, polyester substrates, nylons, blended substrates thereof, etc. It is notable that the term “fabric substrate” or “fabric media substrate” does not include materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

Also as mentioned, a variety of other substrates can be used, including plastic films and metallic foils, to name a few.

The basis weight of the print media, such as the paper, fabric, plastic film, foil, etc., can be from 20 gsm to 500 gsm, from 40 gsm to 400 gsm, from 50 gsm to 250 gsm, or from 75 gsm to 150 gsm, for example. Some media substrates can typically be toward the thinner end of the spectrum, and other media substrates may be thicker, and thus, the weight basis ranges given are provided by example, and are not intended to be limiting.

Regardless of the media substrate used, such substrates can contain or be coated with additives including, but not limited to, colorant (e.g., pigments, dyes, and tints), antistatic agents, brightening agents, nucleating agents, antioxidants, UV stabilizers, and/or fillers and lubricants, for example. Alternatively, the media substrates may be pre-treated in a solution containing the substances listed above before applying other treatments or coating layers.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the polyurethane disclosed herein. This value can be determined, in one example, by dissolving or dispersing a known quantity of a material in organic solvent and then titrating with a solution of potassium hydroxide (KOH) of known concentration for measurement.

“Glass transition temperature” or “Tg,” can be calculated by the Fox equation: copolymer Tg=1/(Wa/(Tg A)+Wb(Tg B)+ . . . ) where Wa=weight fraction of monomer A in the copolymer and TgA is the homopolymer Tg value of monomer A, Wb=weight fraction of monomer B and TgB is the homopolymer Tg value of monomer B, etc. With polyurethane, the hard segments and soft segments can be used to calculate the glass transition temperature of the polymer with the hard and soft segments being calculated based on the various segments used as the homopolymer for the calculation.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane particles can be based on volume of the particle size normalized to a spherical shape for diameter measurement, for example. Particle size can be collected using a Malvern Zetasizer, for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Preparation of Polyurethane Dispersion D1

65.797 grams of polyester diol (Stepanpol® PC-1015-55, from Stepan Company, USA), 22.977 grams of isophorone diisocyanate (IPDI), 3.440 grams of 1,4-butanediol, and 64 grams of acetone were mixed in a 500 mL of 4-neck round bottom flask. A mechanical stirrer with glass rod and Teflon blade was attached. A condenser was also attached. The flask was immersed in a constant temperature bath at 75° C. The system was kept under drying tube. Three (3) drops of dibutyltin dilaurate (DBTDL) was added to initiate the polymerization. Polymerization was continued for 3 hours at 75° C. 0.5 gram samples was withdrawn for wt % NCO titration to confirm the reaction. 4.082 grams of poly(ethylene oxide) methyl ether (Mn=2,000) in 10 grams of acetone was added to the reactor. The polymerization was continued 3 hours at 75° C. 0.5 g of pre-polymer was withdrawn for final wt % NCO titration. The measured NCO value was 2.78 wt %. The theoretical wt % NCO should be 2.79 wt %. The polymerization temperature was reduced to 50° C. 7.368 grams of sodium 2-[(2-aminoethyl)amino]ethanesulfonate (Vestamin® A-95, 50% in water, from Evonik, Germany) in 213.183 grams of DI water was added over 30 minutes. The solution became milky and white color and the milky dispersion was continued to stir for overnight at room temperature. The PUD dispersion was filtered through 400 mesh stainless sieve. Acetone was removed with rotorvap at 50° C. (add 2 drops (20 mg) BYK-011 de-foaming agent, from Byk Additives Ltd., United Kingdom). The final PUD dispersion was filtered through fiber glass filter paper. Particle size measured by Malvern Zetasizer is 178.7 nm; pH was 8.0; and solid content was 28.28 wt %.

### Example 2—Preparation of Polyurethane Dispersion D2

66.624 grams of grams of polyester diol (Stepanpol® PC-1015-55), 22.028 grams of a mixture of 2,2,4-trimethylhexamethylene diisocyanate and 2,4,4-trimethylhexamethylene diisocyanate (TMDI), 3.484 grams of 1,4-butanediol and 64 grams of acetone were mixed in a 500 mL of 4-neck round bottom flask. A mechanical stirrer with glass rod and Teflon blade was attached. A condenser was attached. The flask was immersed in a constant temperature bath at 75° C. The system was kept under drying tube. Three (3) drops of DBTDL was added to initiate the polymerization. Polymerization was continued for 3 hours at 75° C. 0.5 g samples was withdrawn for % NCO titration to confirm the reaction. 4.134 grams of poly(ethylene oxide) methyl ether (Mn=2,000) in 10 grams of acetone was added to the reactor. The polymerization was continued 3 hours at 75° C. 0.5 gram of pre-polymer was withdrawn for final wt % NCO titration. The measured NCO value was 2.82 wt %. The theoretical wt % NCO should be 2.83 wt %. The polymerization temperature was reduced to 50° C. 7.480 grams of sodium 2-[(2-aminoethyl)amino]ethanesulphonate (Vestamin A-95, 50% in water) in 213.230 grams of DI water was added over 30 minutes. The solution became milky and white and the milky dispersion was continued to stir for overnight at room temperature. The PUD dispersion was filtered through 400 mesh stainless sieve. Acetone was removed with rotorvap at 50° C. (add 2 drops (20 mg) BYK-011 de-foaming agent). The final PUD dispersion was filtered through fiber glass filter paper. Particle size measured by Malvern Zetasizer is 182.7 nm; pH was 8.0; and solid content was 31.98 wt %.

### Example 3—Preparation and Application of Coating Compositions to Print Medium

Surface-treatment formulations were prepared and applied to a wood-free paper media substrate at a weight bases of 102 gsm. The coating composition formulation are shown in Tables 2 and 3 below:

TABLE 2
Surface-Treatment Coating Compositions

| | Parts by Weight (pt(s)) | | | |
|---|---|---|---|---|
| Component | C1 | C2 | C3* | C4* |
| Polyurethane | D2 | D2 | Sancure ™ | Sancure ™ |
| Particle | (89 pts) | (89 pts) | 2026 (89 pts) | 2026 (89 pts) |
| Fixing Agent | Ca(NO₃)₂ | Floquat ™ 4820 | Ca(NO₃)₂ | Floquat ™ 4820 |
| | (10 pts) | (10 pts) | (10 pts) | (10 pts) |
| Surfactant | Pluronic L61 | Pluronic L61 | Pluronic L61 | Pluronic L61 |
| | (1 Pt) | (1 Pts) | (1 Pt) | (1 Pt) |
| pH (based on | 6.5 | 6 | N/A | N/A |
| target using pH | | | | |
| control additive) | | | | |
| Solids content** | 5 | 5 | 5 | 5 |
| (Wt %) | | | | |

TABLE 3
Surface-Treatment Coating Compositions

| | Parts by Weight (pt(s)) | | | |
|---|---|---|---|---|
| Coating ID | C5* | C6* | C7 | C8 |
| Polyurethane | Impranil ® | Impranil ® | D2 | D2 |
| Particle | DLN-SD | DLN-SD | (41.5 pts) | (41.5 pts) |
| Fixing Agent | Ca(NO₃)₂ | Floquat ™ 4820 | Ca(NO₃)₂ | Floquat ™ |
| | (10 pts) | (10 pts) | (10 pts) | 4820 (10 pts) |
| Surfactant | Pluronic ® L61 | Pluronic ® L61 | Pluronic ® L61 | Pluronic ® L61 |
| | (1 Pts) | (1 pts) | (2.5 pts) | (2.5 pts) |
| Particulate | | | NuCap ® 100G | NuCap ® 100G |
| filler | | | clay (46 pts) | clay (46 pts) |
| Thickener | | | Tylose ® | Tylose ® |
| | | | HS100K | HS100K |
| | | | (0.6 pts) | (0.6 pts) |
| pH (based on | 6.5 | 6 | 6.5 | 6.5 |
| target using pH | | | | |
| control additive) | | | | |
| Solids content** | 5 | 5 | 51*** | 50*** |
| (Wt %) | | | | |

*Indicates Comparative Polyurethane;
**Water added to control solids content and viscosity at a targeted value of about 45-52 wt % for solids content and 1,500-2,500 cps for viscosity;
***Solids content includes collectively both the polyurethane particle and the particulate filler content;
Sancure ™ polyurethanes are available from Lubrizol Advanced Materials, Inc., USA (unmodified comparative polyurethane);
Impranil ® polyurethanes are available from Covestro AG, Germany (unmodified comparative polyurethane);
Floquat ™ cationic polymer is available from SNF (UK) Ltd., United Kingdom;
Pluronic ® is available from BASF SE, Germany;
NuCap ® is available from Karnin, LLC, USA; and
Tylose ® is available from SE Tylose GmbH & Co. KG, Germany.

### Example 4—Polyurethane Particles and Fixing Agent Compatibility

The coating compositions of Tables 2 and 3 were evaluated for compatibility of the polyurethane particles prepared in accordance with Example 2 (D2), and two types of fixing agent, namely a cationic inorganic salt (Ca(NO₃)₂₎ and a cationic polymer (Floquat™ 4820). The Comparative Examples used the polyurethane polymers as set forth in Tables 2 and 3, where the crashing of the polyurethane with the fixing agent indicated lack of compatibility. The data collected is shown in Table 4, as follows:

TABLE 4
Polyurethane Particles and Fixing Agent Compatibility

| Coating ID | C1 | C2 | C3* | C4* | C5* | C6* | C7 | C8 |
|---|---|---|---|---|---|---|---|---|
| Compatibility | Yes | Yes | No | No | No | No | Yes | Yes |

*Indicates Comparative Example

### Example 5—Image Quality and Image Durability on Coated Print Media

Image quality for the four coated print media prepared in accordance with examples of the present disclosure were evaluated, including measurements for color gamut, color bleed, color uniformity, dry smudge, wet smudge, and sheet opacity. The ink compositions used was from HP 940 cartridges.

Color Gamut was calculated using L*a*b* value of 8 colors (cyan, magenta, yellow, black, red, green, blue, and white) measured with an X-Rite 939 spectro-densitometer using D65 illuminant and 2 degree observer angle.

Color Bleed was determined using a bleed stinger pattern where lines of cyan, magenta, yellow black, red, green and blues inks, passing through solid area filled of each color are printed. The bleed is evaluated visually for scoring.

Color Uniformity was evaluated visually based on solid blocks of the various printed colors. The samples are given a rating score according to 1 to 5 scale, where 1 was the worst performing and 5 was the best performing.

Dry Smudge was a dry to the touch smudge test determined by visual rankings from 1 to 5, with 5 having the least ink smudge and 1 having the most ink smudge after smearing black (R=G=B=0) smudge rectangles immediately after the printing with a neoprene (Safeskin® Hypoclean Critical™ Gloves-HC1380S) glove tips secured by an O-ring on an earplug (Moldex Pura-Fit® #6800) that was attached to a Smeartron pen.

Wet smudge was determined by using a TMI Ink Rub tester on four color (yellow, magenta, cyan and black) printed samples, using a 50 microliters pipette to pipet four equal volumes of DI water onto the center of the colored printed samples. At the end of 5 min wait time, a sled with an attached TexWipe lint free cloth on the sled connector rod of the instrument was used for the smudge cycle rubbing. A score of 3 and above (moderate damage to printed area and/or moderate transfer out of area) was taken as an acceptable level.

Sheet opacity was measured according to TAPPI 425 standard by Technidyne Opacimeter Model BNL-3, 15/d geometry, illuminant A/2°, 89% reflectance baking and paper backing.

TABLE 5
Image Quality and Durability

| | C1 | C2 | C7 | C8 |
|---|---|---|---|---|
| Color gamut | 196K | 209K | 224K | 227K |
| Color bleed | 5 | 5 | 5 | 5 |
| Color uniformity | 4 | 5 | 4 | 4 |
| Dry smudge | 4 | 5 | 5 | 5 |
| Wet smudge | 3 | 3 | 3 | 4 |
| Sheet opacity | 90.4% | 90% | 96% | 95% |

Score 5: Very good; 4: good, 3: acceptable; <3: not acceptable.

As can be seen in Table 5, the polyurethane particles that were found to be compatible with the fixing agents were tested for image quality and durability, and all coated print media performed at least acceptably (wet smudge), and all performed either good or very good in all other categories.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A coating composition, comprising:
water; and
polyurethane particles including sulfonated- or carboxylated-diamine groups, isocyanate-generated amine groups, and polyalkylene oxide side-chains.

2. The coating composition of claim 1, wherein the polyurethane particles have a D50 particle size from 20 nm to 300 nm, and an acid number from 0 mg KOH/g to 30 mg KOH/g.

3. The coating composition of claim 1, wherein the polyalkylene oxide side-chains include polyethylene oxide side-chains, polypropylene oxide side-chains, or a combination thereof, and wherein the polyalkylene oxide side-chains have a number average molecular weight from 500 Mn to 15,000 Mn.

4. The coating composition of claim 1, further comprising a fixing agent including metal inorganic salt, metal organic salt, cationic polymer, or a combination thereof.

5. The media coating composition of claim 4, wherein polyurethane particles and the fixing agent are present in the coating composition at a weight ratio from 2:1 to 20:1.

6. The media coating composition of claim 1, wherein the polyurethane particles further comprising polymerized nonionic aliphatic diols.

7. A coated print medium, comprising:
a media substrate; and
an ink-receiving layer on the media substrate, the ink-receiving layer comprising polyurethane particles including sulfonated- or carboxylated-diamine groups, isocyanate-generated amine groups, and polyalkylene oxide side-chains.

8. The coated print medium of claim 7 wherein the polyalkylene oxide side-chains include polyethylene oxide side-chains, polypropylene oxide side-chains, or a combination thereof, wherein the polyalkylene oxide side-chains have a number average molecular weight from 500 Mn to 15,000 Mn.

9. The coated print medium of claim 7, further comprising fixing agent including metal inorganic salt, metal organic salt, cationic polymer, or a combination thereof.

10. The coated print medium of claim 9, wherein the fixing agent is cationic polymer including an alkylated quaternary polyamine cationic polymer or an ionene cationic polymer.

11. The coated print medium of claim 9, wherein the fixing agent is cationic polymer, and wherein polyurethane particles and the cationic polymer are present in the ink-receiving layer at a weight ratio from 2:1 to 20:1.

12. The coated print medium of claim 7, further comprising inorganic particulate filler having a D50 particle size from 100 nm to 5 μm, wherein the polyurethane particles and the inorganic particulate filler are present in the ink-receiving layer at a weight ratio from 20:1 to 1:3.

13. The coated print medium of claim 7, wherein the media substrate is paper, fabric, plastic film, metallic foil, or a combination or composite thereof.

14. A method of making a coated print medium, comprising:
applying a coating composition as a layer to a media substrate, the coating composition including:
water, and
polyurethane particles including sulfonated- or carboxylated-diamine groups, isocyanate-generated amine groups, and polyalkylene oxide side-chains; and
drying the coating composition to remove water from the media substrate to leave an ink-receiving layer thereon.

15. The method of claim 14, wherein the coating composition further comprises fixing agent including cationic inorganic salt, metal organic salt, cationic polymer, or a combination thereof.
